(19) United States
(12) Patent Application Publication
(10) Pub. No.: US 2025/0119572 A1
(43) Pub. Date: Apr. 10, 2025

(54) MULTI-PASS DECODER-SIDE MOTION VECTOR REFINEMENT

(71) Applicant: MEDIATEK INC., Hsinchu City (TW)

(72) Inventors: Chen-Yen LAI, Hsinchu City (TW); Tzu-Der CHUANG, Hsinchu City (TW); Ching-Yeh CHEN, Hsinchu City (TW)

(21) Appl. No.: 18/730,921

(22) PCT Filed: Jan. 16, 2023
(86) PCT No.: PCT/CN2023/072320

§ 371 Date: Jul. 22, 2024

Related U.S. Application Data
(60) Provisional application No. 63/304,007, filed on Jan. 28, 2022.
(60) Provisional application No. 63/304,008, filed on Jan. 28, 2022.

(51) Int. Cl. H04N 19/513; H04N 19/105; H04N 19/139; H04N 19/176

(52) U.S. Cl. CPC H04N 19/521; H04N 19/105; H04N 19/139; H04N 19/176

(57) ABSTRACT

A method for constraining multi-pass decoder-side motion vector refinement (MP-DMVR) is provided. A video coder receives data for a block of pixels to be encoded or decoded as a current block of a current picture of a video. A video coder receives a motion vector that references a block of pixels in a reference picture based on the received data. A video coder refines the motion vector in a plurality of refinement passes by examining pixels in the reference picture that are identified based on the refined motion vector. The refinement of the motion vector is constrained by a refinement range. The video coder encodes or decodes the current block by using the refined motion vector to produce prediction residuals or to reconstruct the current block.

### CROSS REFERENCE TO RELATED PATENT APPLICATION(S)

The present disclosure is part of a non-provisional application that claims the priority benefit of U.S. Provisional Patent Application Nos. 63/304,007 and 63/304,008, both filed on 28 Jan. 2022. Contents of above-listed applications are herein incorporated by reference.

### TECHNICAL FIELD

The present disclosure relates generally to video coding. In particular, the present disclosure relates to multi-pass decoder-side motion vector refinement (MP-DMVR).

### BACKGROUND

Unless otherwise indicated herein, approaches described in this section are not prior art to the claims listed below and are not admitted as prior art by inclusion in this section.

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one color component associated with CTU, CU, PU, and TU, respectively. Thus, a CTU consists of one luma CTB, two chroma CTBs, and associated syntax elements. A similar relationship is valid for CU, PU, and TU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method for constraining multi-pass decoder-side motion vector refinement (MP-DMVR). A video coder receives data for a block of pixels to be encoded or decoded as a current block of a current picture of a video. A video coder receives a motion vector that references a block of pixels in a reference picture based on the received data. A video coder refines the motion vector in a plurality of refinement passes by examining pixels in the reference picture that are identified based on the refined motion vector. The refinement of the motion vector is constrained by a refinement range. The video coder encodes or decodes the current block by using the refined motion vector to produce prediction residuals or to reconstruct the current block.

The video coder may determine whether DMVR is enabled. In some embodiments, upon determining that activated reference pictures pair exists in two reference picture lists, the video coder receives signaled information related to the refinement of the motion vector. In some embodiments, the signaled information includes an indication for enabling or disabling the refinement of the motion vector at slice level.

In some embodiments, the refinement of the motion vector is constrained to maintain the integer portion of the motion vector while allowing changes only to the fractional portion of the motion vector. In some embodiment, the refinement range is predefined. In some embodiments, the video coder defines the refinement range based on a characteristic of the current block or of the current picture. In some embodiments, the refinement range (or maximum MV refinement) is signaled in at least one of a sequence level, a picture level, and slice level. In some embodiments, the same refinement range is applied to two or more refinement passes. In some embodiments, multiple refinement ranges are signaled for the multiple refinement passes. In some embodiments, the refinement of the motion vector in each refinement pass is constrained by a different refinement range.

In some embodiments, prediction samples within a retrieval range are generated by retrieving pixel samples of a reference picture from a memory, and prediction samples beyond the retrieval range are generated without accessing the memory. For example, the decoder may use padded samples for pixel positions that are outside of the retrieval range. In some embodiments, the retrieval range is defined by motion compensation based on the original motion vector (before refinement). Specifically, the retrieval range encompasses only pixel samples of the reference picture that are identified by the original motion vector for generating a set of prediction samples for motion compensation and not pixel samples that are not identified by the original motion vector for generating the set of prediction samples for motion compensation.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 conceptually illustrates refinement of a prediction candidate by bilateral matching (BM).

FIG. 2 conceptually illustrates maximum motion vector refinement in multi-pass decoder side motion vector refinement (MP-DMVR).

FIG. 3 conceptually illustrates maximum motion vector refinement that preserves the integer portion of the original motion vector.

FIGS. 4A-B conceptually illustrate avoiding retrieving samples not used by original motion vector for motion compensation.

FIG. 5 illustrates an example video encoder that may use DMVR to encode pixel blocks.

FIG. 6 illustrates portions of the video encoder that implement MP-DMVR.

FIG. 7 conceptually illustrates a process for performing MP-DMVR.

FIG. 8 illustrates an example video decoder that may use DMVR to decode and reconstruct pixel blocks.

FIG. 9 illustrates portions of the video decoder that implement MP-DMVR.

FIG. 10 conceptually illustrates a process for performing MP-DMVR.

FIG. 11 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Decoder-Side Motion Vector Refinement (DMVR)

Decoder side motion vector refinement (DMVR) is an operation by which a video decoder may perform to increase the precision of inter-prediction (e.g., merge mode) without additional signaling. The video decoder refines an initial MV or prediction candidate (e.g., from the merge mode) by searching the reference pictures for better matching reference pixels or reference blocks based on bilateral matching cost. The bilateral matching cost for a prediction candidate may be determined by comparing or matching the reference pixels (or block) pointed to by the prediction candidate with the reference pixels pointed to by the mirror of the prediction candidate.

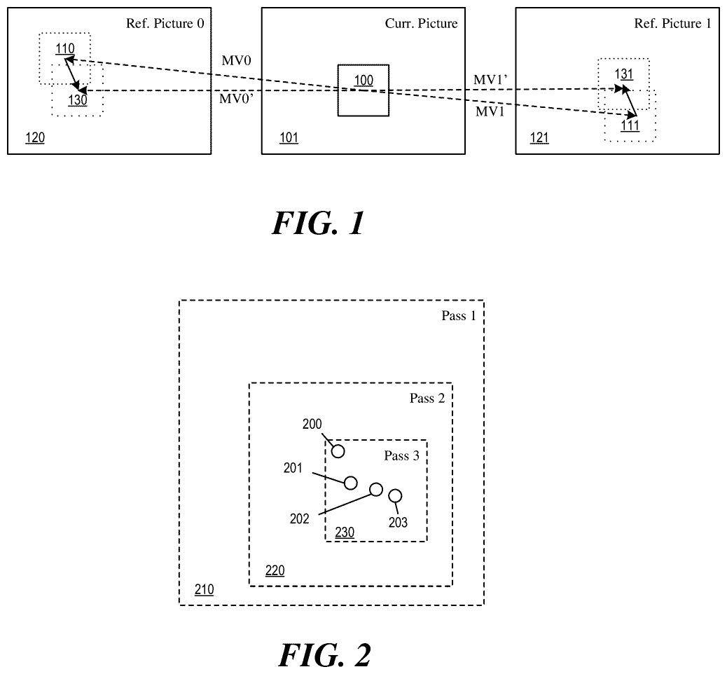

FIG. 1 conceptually illustrates refinement of a prediction candidate by bilateral matching (BM). MV0 is an initial motion vector or a prediction candidate, MV1 is the mirror of MV0. MV0 references a block 110 in reference picture 120. MV1 reference a block 111 in a reference picture 121. The figure shows MV0 and MV1 being refined to form MV0′ and MV1′, which reference blocks 130 and 131, respectively. The refinement is performed according to bilateral matching, such that the refined motion vector pair (MV0′ & MV1′) has better bilateral matching cost than the initial motion vector pair (MV0 & MV1). MV0′-MV0 (i.e., MVD0) and MV1′-MV1 (i.e., MVD1) are constrained to be equal in magnitude but opposite in direction.

### II. Bi-Directional Optical Flow (BDOF)

In some embodiments, the bi-directional optical flow (BDOF) is used to refine the bi-prediction signal of a CU at sub-block level. VVC includes BDOF mode for refining bi-prediction signal by using sample gradients and a set of derived displacement. The BDOF mode is based on the optical flow concept, which assumes that the motion of an object is smooth. For each sub-block (e.g., 4×4, 8×8), a motion refinement is calculated by minimizing the difference between the L0 and L1 prediction samples. The motion refinement is then used to adjust the bi-predicted sample values in the sub-block.

### III. Multi-Pass Decoder-Side Motion Vector Refinement

In some embodiments, the video coder performs multi-pass decoder-side motion vector refinement (MP-DMVR). In MP-DMVR, the MVs are refined by a searching process in a first pass and a second pass. While in a third pass, the bi-directional optical flow (BDOF) process is used to refine the MVs. After that, motion compensation will be performed again with the refined MVs.

In some embodiments, a multi-pass DMVR method is applied in regular merge mode if the selected merge candidate meets certain conditions for DMVR. In the first pass, BM is applied to the current coding block. In the second pass, BM
is applied to each 16×16 subblock within the coding block. In the third pass, MV in each 8×8 subblock is refined by applying BDOF.

### A. Constraint on Maximum MV Refinement

To facilitate hard-ware implementations of MP-DMVR, the maximum MV refinement (the difference between the initial MV and the refined MV), is constrained. In some embodiments, the maximum MV refinements are constrained to a pre-defined value and the constraint will be applied to all passes of MP-DMVR. For example, only candidates defined within the maximum MV refinements can be searched in the first and second passes. And if the MV refinements derived in the third pass is larger than one-pel pixel (or 2-pel pixel), the MV refinements are clipped to one-pel (or 2-pel) in all passes of MP-DMVR.

In some embodiments, the maximum MV refinements in different passes of MP-DMVR can be constrained to different pre-defined values. For example, the maximum value of MV refinement used for the first pass may be 2-pel pixel; the maximum value of MV refinement used for the second pass may be 1-pel pixel; the maximum value of MV refinement used for the third pass may be clipped to half-pel pixel.

FIG. 2 conceptually illustrates maximum MV refinement in multi-pass DMVR. Specifically, the figure shows different passes of the MP-DMVR having different values for maximum MV refinement (or search range). As illustrated, a video coder performing MP-DMVR starts with an original MV 200. After a first pass of searching, the video decoder generates a first refined MV 201. After a second pass of searching, the video coder generates a second refined MV 202. After a third pass of searching the video coder generates a third refined MV 203. At each pass, a defined search range constrains the refinement of the MV (i.e., the maximum MV refinement) such that the refined MV after each refinement pass must stay within the search range of the pass, such that the modification of the MV due to the MV refinement of the pass is constrained to be less than the maximum MV refinement of the pass. For the first pass, a range 210 limits the refinement of the MV. For the second pass, a range 220 limits the refinement of the MV. For the third pass, a range 230 limits the refinement of the MV.

In some embodiments, one maximum MV refinement is applied for the first and second passes of MP-DMVR. The other passes do not have any maximum MV refinement constraint, or different maximum MV refinement constraints are applied to other passes. For example, the maximum MV refinements used for first pass and second pass are same or larger than the maximum MV refinement used for the third pass. In some embodiments, the maximum MV refinements used for second pass and third pass are same, and there is no maximum MV refinement constraint applied to the first pass.

In some embodiments, the maximum MV refinement applied to MP-DMVR is determined based on a characteristic of the current picture or current block being coded. Specifically, the maximum MV refinement may be defined based on TB size, block size, sub-block size, inter-prediction direction (e.g., uni-prediction or bi-prediction), prediction modes (e.g. merge mode, AMVP mode, MMVD, affine mode, etc.), bilateral matching types of MP-DMVR (e.g., bi-direction, List 0 only, or List 1 only), temporal distance between reference pictures and the current picture, temporal distance between two reference pictures, or picture resolution.

In some embodiments, the maximum MV refinement is defined as the maximum value that does not change the integer part of the original MV. That is, the required integer reference samples before refinement and after refinement shall be the same. The MVs before refinement and after refinement differ only at the fractional part.

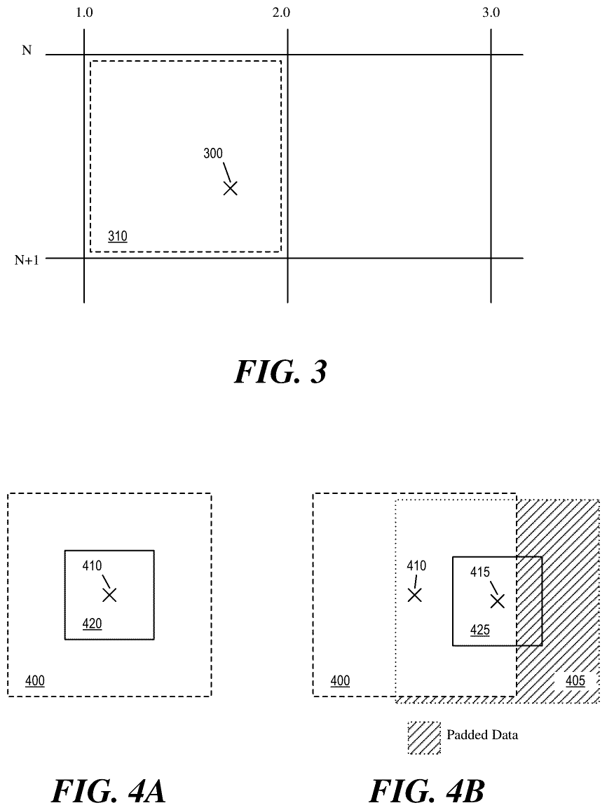

FIG. 3 conceptually illustrates maximum MV refinement that preserves the integer portion of the original MV. The figure illustrates an MV 300 that is being refined. The x-value of the MV 300 is between 1.0 and 2.0, so the integer portion of the MV is 1. The y-value of the MV 300 is between integers N and N+1. The refinement of the MV 300, or the refined MV, is constrained to preserve the integer portion of the MV, such that the refined MV is constrained to have x-value between 1.0 and 2.0 and y-value between N and N+1. In other words, maximum MV refinement constrains the refined MV to be between 1.0 and 2.0 in x-direction and between N and N+1 in y-direction. The refinement range is illustrated as a range 310 in the figure (between 1.0 and 2.0 in the x-direction and between N and N+1 in the y-direction.)

In some embodiments, the maximum MV refinement is signaled in the sequence, picture, and/or slice level. In some embodiments, multiple maximum MV refinements are signaled for different passes. In some embodiments, when the signaled maximum MV refinement is equal to 0, the corresponding pass is skipped in the MP-DMVR.

### B. DMVR Motion Compensation

To avoid fetching additional data because of MP-DMVR motion refinement operations, in some embodiments, the video coder may use padding samples in motion compensation if the refined MVs reference additional samples (from memory buffer) that are not used by original motion compensation (MC) operations. (Original MC means MC that is performed based on original MV without refinement.) In some of these embodiments, MV refinements constraints (described in Section III-A) are not applied. In some embodiments, the nearest integer samples are used if the refined MVs reference additional samples compared with motion compensation using original MVs.

FIGS. 4A-B conceptually illustrate avoiding retrieving samples not used by original motion vector for motion compensation. FIG. 4A illustrates an original MV 410 that references a reference block 420. To perform motion compensation (MC) based on the reference block 420, data in a memory range 400 are to be fetched. In other words, the memory range 400 is defined based on what is needed by the motion compensation based on the original MV 410. FIG. 4B illustrates the MV refinement process producing a refined MV 415 that references a reference block 425. To perform motion compensation based on the reference block 425, data in a memory range 405 need to be fetched. However, a portion (illustrated as shaded) of the memory range 405 falls outside of the memory range 400. Rather than fetching additional data from beyond the memory range 400, the video coder may generate padding data or samples to be used for motion compensation so that the memory buffer requirement could be lower.

In some embodiments, available reference samples that can be used in the MP-DMVR and/or final MC (the MC operation that is performed after MV refinement to reconstruct the block) are constrained to one pre-defined region. For example, one region is defined according to the refined MV in the second pass, and the derivation process in the third pass and final MC are constrained to not access reference samples that are not included in this defined region.

In some embodiments, the region is defined according to the refined MV in the first pass, and the subsequent operations (including the second pass, the third pass, and the final MC) are constrained to not access reference samples that are not included in this region. In some embodiments, the region is defined according to the initial MV, and the subsequent operations (including the first pass, the second pass, the third pass, and the final MC) are constrained to not access reference samples that are not included in this region. In some embodiments, if a reference sample outside of the defined region is required in the subsequent operations, a padding sample is used in place of the reference sample that is outside of the defined region. The range 400 of FIG. 4A-B can be such a predefined region, such that the video coder is constrained to not access reference samples that are not included in the region 400 during MP-DMVR. If a reference sample outside of the defined region 400 is required for MC, a padding sample is used instead of the reference sample.

### C. DMVR Enabled Check at CU-Level

In some embodiments, MP-DMVR is enabled only if bi-prediction is used, and two reference pictures are from different direction (true bi-prediction) with equal distance picture order count (POC). Thus, only if at least one activated reference pictures pair (e.g., one from List 0 (L0) and the other one from List 1 (L1)) in two reference picture lists (L0, L1) satisfies the above mentioned DMVR enabled conditions, DMVR can be applied in current CU.

In some embodiments, the video coder checks the activated reference pictures in reference picture lists before the signaling DMVR related information (e.g., bmMergeFlag). For example, if no activated reference pictures pair in two reference picture lists (L0, L1) satisfies the above mentioned DMVR enabled conditions, the video coder does not signal bmMergeFlag. And it will be set to be zero by default by the video encoder and the video decoder. For another example, a bitstream conformance constraint is used to constrain bmMergeFlag. That is, if no activated reference pictures pair in two reference picture lists (L0, L1) satisfies the above mentioned DMVR enabled conditions, bmMergeFlag is set to zero.

### D. DMVR Enabled Check at Slice-Level

In some embodiments, the activated reference pictures in reference picture lists are checked before the DMVR related information in slice-level (e.g., sh_bmMergeFlag) are signaled. In this way, if no activated reference pictures pair in two reference picture lists (L0, L1), sh_bmMergeFlag is set to zero in slice header. After that, no other DMVR related information (e.g., bmMergeFlag) are sent at CU-level which referenced this slice header. For example, if no activated reference pictures pair in two reference picture lists (L0, L1) satisfies the above mentioned DMVR enabled conditions, sh_bmMergeFlag shall not be signaled and set to be zero by default. For another example, a bitstream conformance constraint is used to signal sh_bmMergeFlag. That is, if no activated reference pictures pair in two reference picture lists (L0, L1) satisfies the above mentioned DMVR enabled conditions, sh_bmMergeFlag shall be zero.

In some embodiments, the flag, sh_bmMergeFlag, is further combined with ph_dmvr_disabled_flag, which is signaled at picture header and used to indicate disabling DMVR process in current picture in VVC. However, the reference picture list (RPL) can be changed at slice level, not picture level only. Thus, in some embodiments, sh_dmvr_disabled_flag is signaled at slice level, especially when RPL is allowed to change at slice level and multiple slices exist in one picture.

In some embodiments, if no activated reference pictures pair in two reference picture lists (L0, L1) satisfies the above mentioned DMVR enabled conditions, sh_dmvr_disabled_flag shall be one. In some embodiments, ph_dmvr_disabled_flag is signaled at picture level, and sh_dmvr_disabled flag in slice level is conditionally signaled based on the value of ph_dmvr_disabled_flag. When sh_dmvr_disabled flag is not signaled, the value of sh_dmvr_disabled flag is inferred according to ph_dmvr_disabled_flag. As for the CU-level flag bmMergeFlag, it is conditionally signaled according to the value of the flag sh_dmvr_disabled_flag.

Any of the foregoing proposed methods can be implemented in encoders and/or decoders. For example, any of the proposed methods can be implemented in a DMVR module of an encoder and/or a decoder. Alternatively, any of the proposed methods can be implemented as a circuit coupled to the DMVR module of the encoder and/or the decoder.

### IV. Example Video Encoder

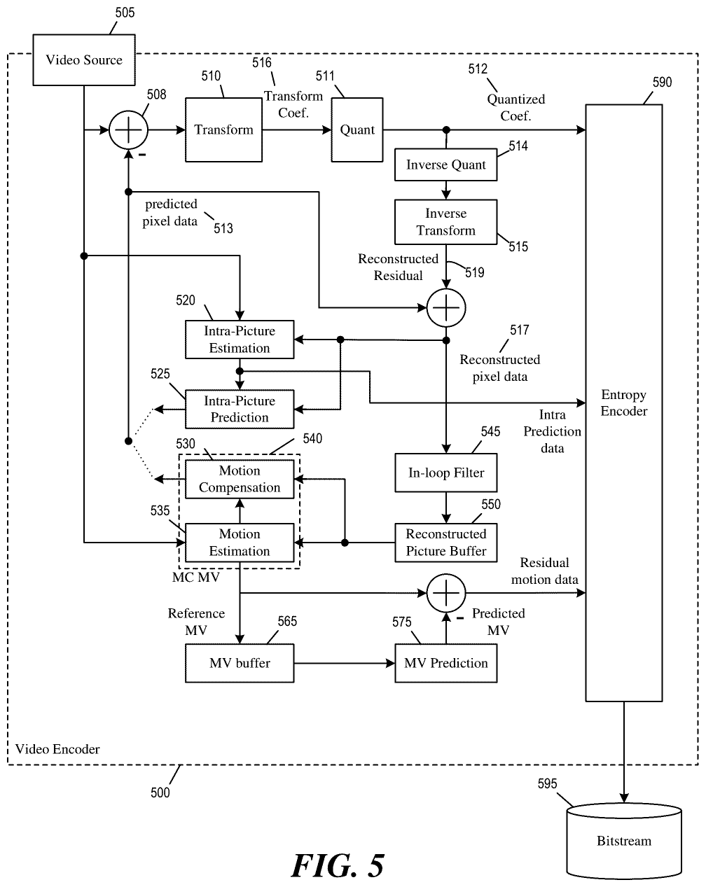

FIG. 5 illustrates an example video encoder 500 that may use DMVR to encode pixel blocks. As illustrated, the video encoder 500 receives input video signal from a video source 505 and encodes the signal into bitstream 595. The video encoder 500 has several components or modules for encoding the signal from the video source 505, at least including some components selected from a transform module 510, a quantization module 511, an inverse quantization module 514, an inverse transform module 515, an intra-picture estimation module 520, an intra-prediction module 525, a motion compensation module 530, a motion estimation module 535, an in-loop filter 545, a reconstructed picture buffer 550, a MV buffer 565, and a MV prediction module 575, and an entropy encoder 590. The motion compensation module 530 and the motion estimation module 535 are part of an inter-prediction module 540.

In some embodiments, the modules 510-590 are modules of software instructions being executed by one or more processing units (e.g., a processor) of a computing device or electronic apparatus. In some embodiments, the modules 510-590 are modules of hardware circuits implemented by one or more integrated circuits (ICs) of an electronic apparatus. Though the modules 510-590 are illustrated as being separate modules, some of the modules can be combined into a single module.

The video source 505 provides a raw video signal that presents pixel data of each video frame without compression. A subtractor 508 computes the difference between the raw video pixel data of the video source 505 and the predicted pixel data 513 from the motion compensation module 530 or intra-prediction module 525. The transform module 510 converts the difference (or the residual pixel data or residual signal 508) into transform coefficients (e.g., by performing Discrete Cosine Transform, or DCT). The quantization module 511 quantizes the transform coefficients into quantized data (or quantized coefficients) 512, which is encoded into the bitstream 595 by the entropy encoder 590.

The inverse quantization module 514 de-quantizes the quantized data (or quantized coefficients) 512 to obtain transform coefficients, and the inverse transform module 515 performs inverse transform on the transform coefficients to produce reconstructed residual 519. The reconstructed residual 519 is added with the predicted pixel data 513 to produce reconstructed pixel data 517. In some embodiments, the reconstructed pixel data 517 is temporarily stored in a line buffer (not illustrated) for intra-picture prediction and spatial MV prediction. The reconstructed pixels are filtered by the in-loop filter 545 and stored in the reconstructed picture buffer 550. In some embodiments, the reconstructed picture buffer 550 is a storage external to the video encoder 500. In some embodiments, the reconstructed picture buffer 550 is a storage internal to the video encoder 500.

The intra-picture estimation module 520 performs intra-prediction based on the reconstructed pixel data 517 to produce intra prediction data. The intra-prediction data is provided to the entropy encoder 590 to be encoded into bitstream 595. The intra-prediction data is also used by the intra-prediction module 525 to produce the predicted pixel data 513.

The motion estimation module 535 performs inter-prediction by producing MVs to reference pixel data of previously decoded frames stored in the reconstructed picture buffer 550. These MVs are provided to the motion compensation module 530 to produce predicted pixel data.

Instead of encoding the complete actual MVs in the bitstream, the video encoder 500 uses MV prediction to generate predicted MVs, and the difference between the MVs used for motion compensation and the predicted MVs is encoded as residual motion data and stored in the bitstream 595.

The MV prediction module 575 generates the predicted MVs based on reference MVs that were generated for encoding previously video frames, i.e., the motion compensation MVs that were used to perform motion compensation. The MV prediction module 575 retrieves reference MVs from previous video frames from the MV buffer 565. The video encoder 500 stores the MVs generated for the current video frame in the MV buffer 565 as reference MVs for generating predicted MVs.

The MV prediction module 575 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 595 by the entropy encoder 590.

The entropy encoder 590 encodes various parameters and data into the bitstream 595 by using entropy-coding techniques such as context-adaptive binary arithmetic coding (CABAC) or Huffman encoding. The entropy encoder 590 encodes various header elements, flags, along with the quantized transform coefficients 512, and the residual motion data as syntax elements into the bitstream 595. The bitstream 595 is in turn stored in a storage device or transmitted to a decoder over a communications medium such as a network.

The in-loop filter 545 performs filtering or smoothing operations on the reconstructed pixel data 517 to reduce the artifacts of coding, particularly at boundaries of pixel blocks. In some embodiments, the filtering operation performed includes sample adaptive offset (SAO). In some embodiment, the filtering operations include adaptive loop filter (ALF).

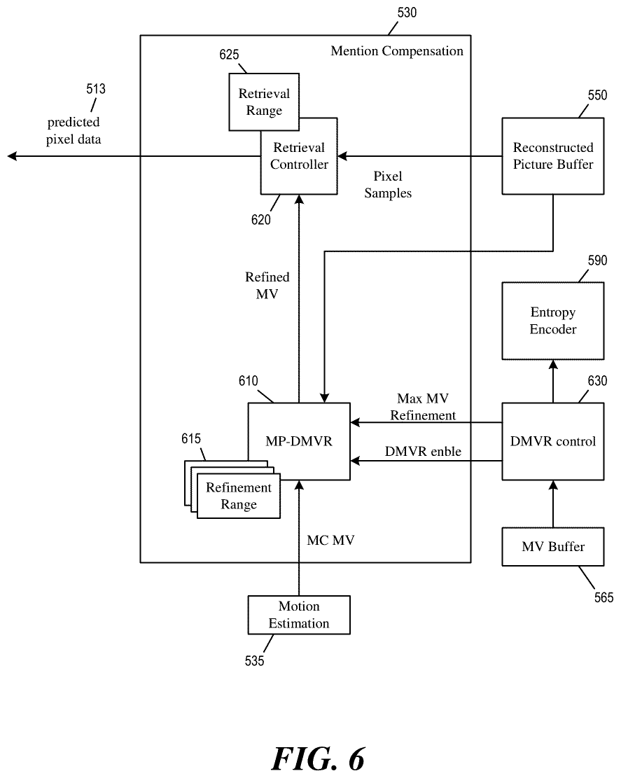

FIG. 6 illustrates portions of the video encoder 500 that implement MP-DMVR. Specifically, the figure illustrates the components of the motion compensation module 530 of the video encoder 500. As illustrated, the motion compensation module 540 receives the motion compensation MV (MC MV), which provided by the motion estimation module 535.

A MP-DMVR module 610 performs MP-DMVR process by using the MC MV as the initial or original MV. The MP-DMVR module 610 in multiple passes uses content of the reconstructed picture buffer 550 to calculate bilateral matching costs of MVs, which are used to refine the original MV in multiple passes. During each pass, the refinement of the MV is constrained to a predefined refinement range 615 (or maximum MV refinement). Such predefined refinement range may be a constraint based on integer portion of the original MV (as described by reference to FIG. 3 above.) A DMVR control module 630 may provide the predefined refinement range to the entropy encoder 590 to be encoded as syntax elements in slice or picture or sequence level of the bitstream 595. The DMVR control module 630 may define the refinement range based on a characteristic of the current block or the current picture.

The DMVR control module 630 may also enable or disable DMVR operations of the MP-DMVR module 610 based on whether activated reference pictures pair exists in two reference picture lists.

The MP-DMVR module 610 performs the MP-DMVR to produce a refined MV, which is used by a retrieval controller 620 to generate the predicted pixel data 513. The retrieval controller 620 operate according to a retrieval range 625. Specifically, for pixel positions that fall within the retrieval range 625, the retrieval controller 620 retrieves pixel samples from the encoded picture buffer 550 as the predicted pixel data 513. For pixel positions that are outside of the retrieval range 625, the retrieval controller 620 does not access the encoded picture buffer 550 but instead generate padding samples as predicted pixel data 513. In some embodiments, the retrieval range correspond to the original motion compensation, i.e., the pixels positions that are to be retrieved as predicted pixel data based on the original MV (without refinement) for motion compensation.

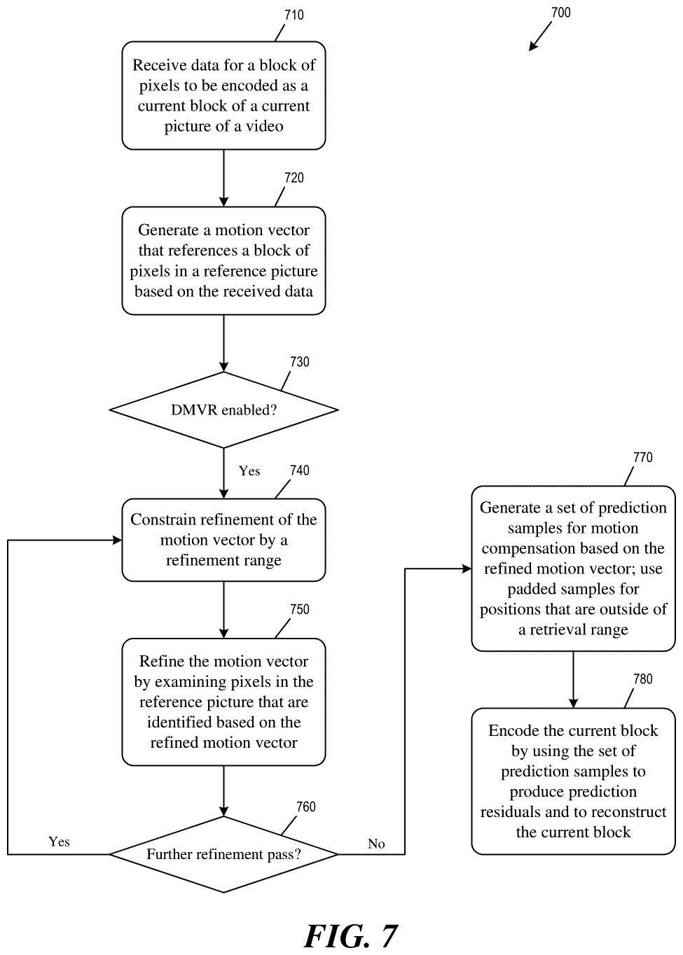

FIG. 7 conceptually illustrates a process 700 for performing MP-DMVR. In some embodiments, one or more processing units (e.g., a processor) of a computing device implementing the encoder 500 performs the process 700 by executing instructions stored in a computer readable medium. In some embodiments, an electronic apparatus implementing the encoder 500 performs the process 700.

The encoder receives (at block 710) data to be encoded as a current block of pixels in a current picture of video.

The encoder generates (at block 720) a motion vector that references a block of pixels in a reference picture based on the received data. The motion vector may be provided by a motion estimation process.

The encoder determines (at block 730) whether DMVR is enabled. If DMVR is enabled, the process 700 proceeds to block 740. Otherwise, the video encoder proceeds to perform other operations for encoding the current block. In some embodiments, upon determining that activated reference pictures pair exists in two reference picture lists, the encoder receives signaled information related to the refinement of the motion vector (or DMVR information such as sh_bmMergeFlag.) In some embodiments, the signaled information includes an indication (e.g., sh_dmvr_disabled flag) for enabling or disabling the refinement of the motion vector at slice level (e.g., in a slice header).

The encoder constrains (at block 740) the refinement of the motion vector by a refinement range. In other words, the encoder does not modify the motion vector beyond the refinement range in search of better matching reference pixels. In some embodiments, the modification of the motion vector is constrained to maintain the integer portion of the motion vector while allowing changes only to the fractional portion of the motion vector (the refinement range is defined by the integer portion of the MV.)

In some embodiment, the refinement range is predefined. In some embodiments, the refinement range (or maximum MV refinement) is signaled in at least one of a sequence level, a picture level, and slice level. In some embodiments, the same refinement range is applied to two or more refinement passes. In some embodiments, multiple refinement ranges are signaled for the multiple refinement passes.

The encoder refines (at block 750) the motion vector by examining pixels in the reference picture that are identified based on the refined motion vector. The refinement of the motion vector is constrained by a refinement range.

The encoder determines (at block 760) whether a further refinement pass is to be performed. If there is a further MV refinement pass (DMVR pass), the process returns to 740. Otherwise, the process proceeds to block 770. In the first and second DMVR passes, the video encoder may refine the MV by searching for better matching reference pixels in the reference picture; in the third DMVR pass, the encoder may use BDOF process to refine the MVs. In some embodiments, the refinement of the motion vector in each refinement pass is constrained by a different refinement range.

The encoder generates (at block 770) a set of prediction samples for motion compensation based on the refined motion vector. Specifically, prediction samples within a retrieval range are generated by retrieving pixel samples of a reference picture from a memory, and prediction samples beyond the retrieval range are generated without accessing the memory. For example, the encoder may use padded samples for pixel positions that are outside of the retrieval range. In some embodiments, the retrieval range is defined by motion compensation based on the original motion vector (before refinement). Specifically, the retrieval range encompasses only pixel samples of the reference picture that are identified by the original motion vector for generating a set of prediction samples for motion compensation and not pixel samples that are not identified by the original motion vector for generating the set of prediction samples for motion compensation.

The encoder encodes (at block 780) the current block by using the set of predicted samples to produce prediction residuals and to reconstruct the current block.

### V. Example Video Decoder

In some embodiments, an encoder may signal (or generate) one or more syntax element in a bitstream, such that a decoder may parse said one or more syntax element from the bitstream.

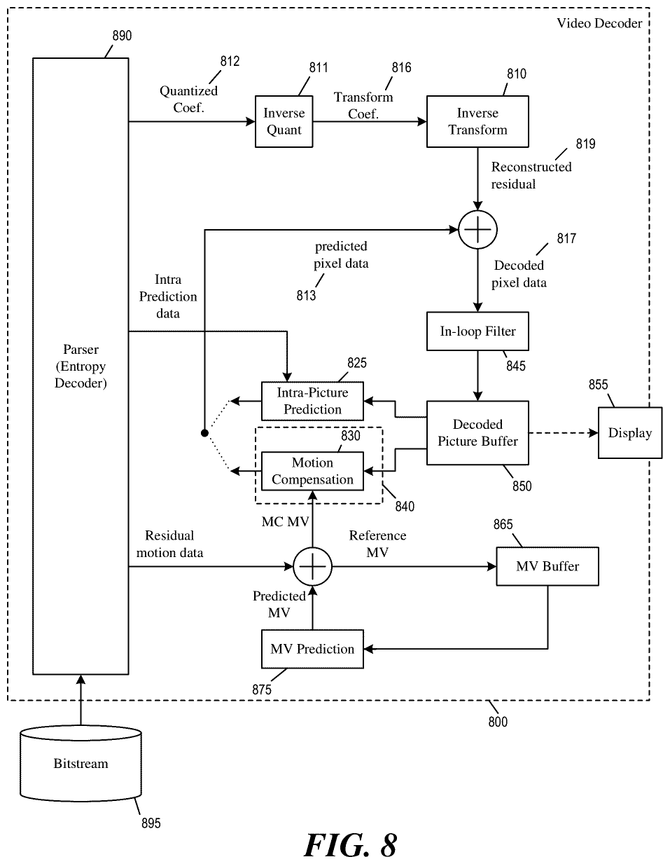

FIG. 8 illustrates an example video decoder 800 that may use DMVR to decode and reconstruct pixel blocks. As illustrated, the video decoder 800 is an image-decoding or video-decoding circuit that receives a bitstream 895 and decodes the content of the bitstream into pixel data of video frames for display. The video decoder 800 has several components or modules for decoding the bitstream 895, including some components selected from an inverse quantization module 811, an inverse transform module 810, an intra-prediction module 825, a motion compensation module 830, an in-loop filter 845, a decoded picture buffer 850, a MV buffer 865, a MV prediction module 875, and a parser 890. The motion compensation module 830 is part of an inter-prediction module 840.

In some embodiments, the modules 810-890 are modules of software instructions being executed by one or more processing units (e.g., a processor) of a computing device. In some embodiments, the modules 810-890 are modules of hardware circuits implemented by one or more ICs of an electronic apparatus. Though the modules 810-890 are illustrated as being separate modules, some of the modules can be combined into a single module.

The parser 890 (or entropy decoder) receives the bitstream 895 and performs initial parsing according to the syntax defined by a video-coding or image-coding standard. The parsed syntax element includes various header elements, flags, as well as quantized data (or quantized coefficients) 812. The parser 890 parses out the various syntax elements by using entropy-coding techniques such as context-adaptive binary arithmetic coding (CABAC) or Huffman encoding.

The inverse quantization module 811 de-quantizes the quantized data (or quantized coefficients) 812 to obtain transform coefficients, and the inverse transform module 810 performs inverse transform on the transform coefficients 816 to produce reconstructed residual signal 819. The reconstructed residual signal 819 is added with predicted pixel data 813 from the intra-prediction module 825 or the motion compensation module 830 to produce decoded pixel data 817. The decoded pixels data are filtered by the in-loop filter 845 and stored in the decoded picture buffer 850. In some embodiments, the decoded picture buffer 850 is a storage external to the video decoder 800. In some embodiments, the decoded picture buffer 850 is a storage internal to the video decoder 800.

The intra-prediction module 825 receives intra-prediction data from bitstream 895 and according to which, produces the predicted pixel data 813 from the decoded pixel data 817 stored in the decoded picture buffer 850. In some embodiments, the decoded pixel data 817 is also stored in a line buffer (not illustrated) for intra-picture prediction and spatial MV prediction.

In some embodiments, the content of the decoded picture buffer 850 is used for display. A display device 855 either retrieves the content of the decoded picture buffer 850 for display directly, or retrieves the content of the decoded picture buffer to a display buffer. In some embodiments, the display device receives pixel values from the decoded picture buffer 850 through a pixel transport.

The motion compensation module 830 produces predicted pixel data 813 from the decoded pixel data 817 stored in the decoded picture buffer 850 according to motion compensation MVs (MC MVs). These motion compensation MVs are decoded by adding the residual motion data received from the bitstream 895 with predicted MVs received from the MV prediction module 875.

The MV prediction module 875 generates the predicted MVs based on reference MVs that were generated for decoding previous video frames, e.g., the motion compensation MVs that were used to perform motion compensation. The MV prediction module 875 retrieves the reference MVs of previous video frames from the MV buffer 865. The video decoder 800 stores the motion compensation MVs generated for decoding the current video frame in the MV buffer 865 as reference MVs for producing predicted MVs.

The in-loop filter 845 performs filtering or smoothing operations on the decoded pixel data 817 to reduce the artifacts of coding, particularly at boundaries of pixel blocks. In some embodiments, the filtering operation performed includes sample adaptive offset (SAO). In some embodiment, the filtering operations include adaptive loop filter (ALF).

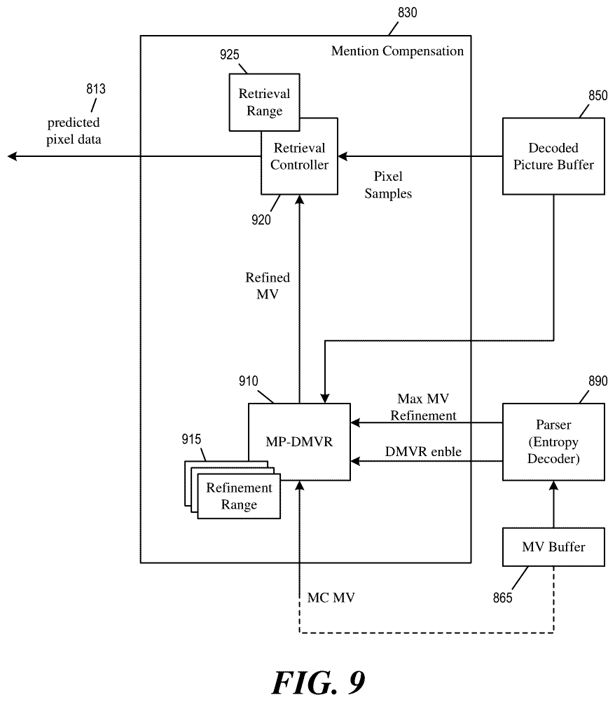

FIG. 9 illustrates portions of the video decoder 800 that implement MP-DMVR. Specifically, the figure illustrates the components of the motion compensation module 830 of the video decoder 800. As illustrated, the motion compensation module 840 receives the motion compensation MV (MC MV), which is derived based on information received from the entropy decoder 890 and the MV buffer 865 as described above by reference to FIG. 8.

A MP-DMVR module 910 performs MP-DMVR process by using the MC MV as the initial or original MV. The MP-DMVR module 910 in multiple passes uses content of the decoded picture buffer 850 to calculate bilateral matching costs of MVs, which are used to refine the original MV in multiple passes. During each pass, the refinement of the MV is constrained to a predefined refinement range 915 (or maximum MV refinement). Such predefined refinement range may be a constraint based on integer portion of the original MV (as described by reference to FIG. 3 above,) or may be provided by the entropy decoder 890 based on syntax elements in slice or picture or sequence level of the bitstream 895. In some embodiments, the video decoder defines the refinement range based on a characteristic of the current block or of the current picture. The entropy decoder 890 may also enable or disable DMVR operations of the MP-DMVR module 910 based on whether activated reference pictures pair exists in two reference picture lists.

The MP-DMVR module 910 performs the MP-DMVR process to produce a refined MV, which is used by a retrieval controller 920 to generate the predicted pixel data 813. The retrieval controller 920 operate according to a retrieval range 925. Specifically, for pixel positions that fall within the retrieval range 925, the retrieval controller 920 retrieves pixel samples from the decoded picture buffer 850 as the predicted pixel data 813. For pixel positions that are outside of the retrieval range 925, the retrieval controller 920 does not access the decoded picture buffer 850 but instead generate padding samples as predicted pixel data 813. In some embodiments, the retrieval range correspond to the original motion compensation, i.e., the pixels positions that are to be retrieved as predicted pixel data based on the original MV (without refinement) for motion compensation.

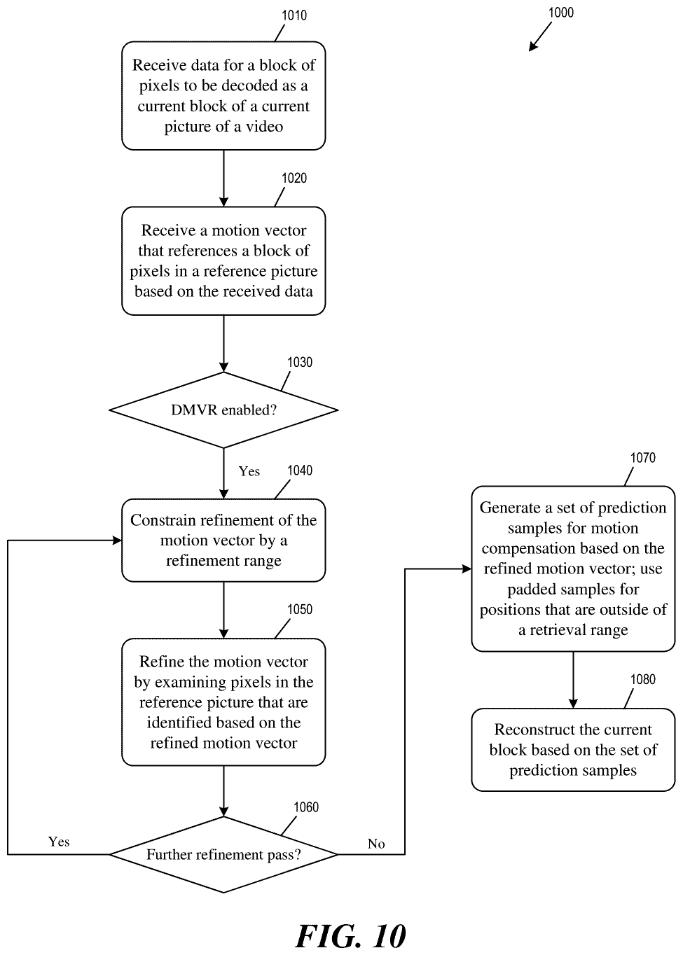

FIG. 10 conceptually illustrates a process 1000 for performing MP-DMVR. In some embodiments, one or more processing units (e.g., a processor) of a computing device implementing the decoder 800 performs the process 1000 by executing instructions stored in a computer readable medium. In some embodiments, an electronic apparatus implementing the decoder 800 performs the process 1000.

The decoder receives (at block 1010) data to be decoded as a current block of pixels in a current picture of video.

The decoder receives (at block 1020) a motion vector that references a block of pixels in a reference picture based on the received data.

The decoder determines (at block 1030) whether DMVR is enabled. If DMVR is enabled, the process 1000 proceeds to block 1040. Otherwise, the video decoder proceeds to perform other operations for decoding the current block. In some embodiments, upon determining that activated reference pictures pair exists in two reference picture lists, the decoder receives signaled information related to the refinement of the motion vector (or DMVR information such as sh_bmMergeFlag.) In some embodiments, the signaled information includes an indication (e.g., sh_dmvr_disabled flag) for enabling or disabling the refinement of the motion vector at slice level (e.g., in a slice header).

The decoder constrains (at block 1040) the refinement of the motion vector by a refinement range. In other words, the decoder does not modify the motion vector beyond the refinement range in search of better matching reference pixels. In some embodiments, the modification of the motion vector is constrained to maintain the integer portion of the motion vector while allowing changes only to the fractional portion of the motion vector (the refinement range is defined by the integer portion of the MV) In some embodiment, the refinement range is predefined. In some embodiments, the video decoder defines the refinement range based on a characteristic of the current block or of the current picture. In some embodiments, the refinement range (or maximum MV refinement) is signaled in at least one of a sequence level, a picture level, and slice level. In some embodiments, the same refinement range is applied to two or more refinement passes. In some embodiments, multiple refinement ranges are signaled for the multiple refinement passes.

The decoder refines (at block 1050) the motion vector by examining pixels in the reference picture that are identified based on the refined motion vector. The refinement of the motion vector is constrained by a refinement range.

The decoder determines (at block 1060) whether a further refinement pass is to be performed. If there is a further MV refinement pass (DMVR pass), the process returns to 1040. Otherwise, the process proceeds to block 1070. In the first and second DMVR passes, the video decoder may refine the MV by searching for better matching reference pixels in the reference picture; in the third DMVR pass, the decoder may use BDOF process to refine the MVs. In some embodiments, the refinement of the motion vector in each refinement pass is constrained by a different refinement range.

The decoder generates (at block 1070) a set of prediction samples for motion compensation based on the refined motion vector. Specifically, prediction samples within a retrieval range are generated by retrieving pixel samples of a reference picture from a memory, and prediction samples beyond the retrieval range are generated without accessing the memory. For example, the decoder may use padded samples for pixel positions that are outside of the retrieval range. In some embodiments, the retrieval range is defined by motion compensation based on the original motion vector (before refinement). Specifically, the retrieval range encompasses only pixel samples of the reference picture that are identified by the original motion vector for generating a set of prediction samples for motion compensation and not pixel samples that are not identified by the original motion vector for generating the set of prediction samples for motion compensation.

The decoder reconstructs (at block 1080) the current block based on the set of predicted samples (by e.g., adding inverse transformed prediction residuals.) The decoder may then provide the reconstructed current block for display as part of the reconstructed current picture.

### VI. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

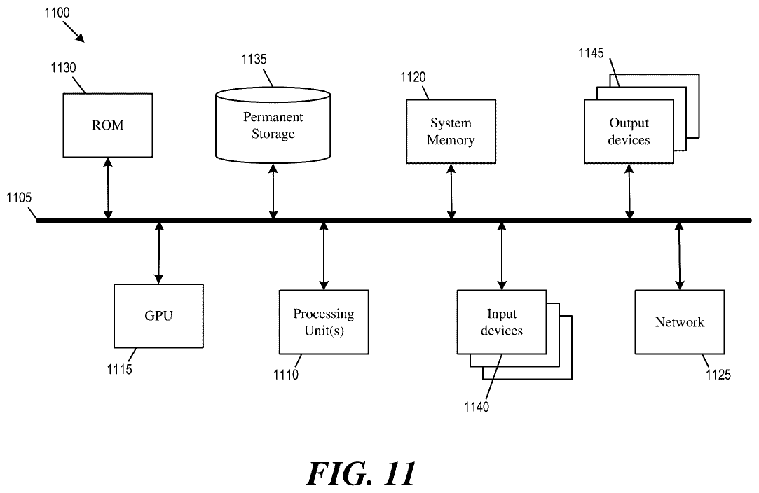

FIG. 11 conceptually illustrates an electronic system 1100 with which some embodiments of the present disclosure are implemented. The electronic system 1100 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1100 includes a bus 1105, processing unit(s) 1110, a graphics-processing unit (GPU) 1115, a system memory 1120, a network 1125, a read-only memory 1130, a permanent storage device 1135, input devices 1140, and output devices 1145.

The bus 1105 collectively represents all system, peripheral, and chipset buses that communicatively connect the numerous internal devices of the electronic system 1100. For instance, the bus 1105 communicatively connects the processing unit(s) 1110 with the GPU 1115, the read-only memory 1130, the system memory 1120, and the permanent storage device 1135.

From these various memory units, the processing unit(s) 1110 retrieves instructions to execute and data to process in order to execute the processes of the present disclosure. The processing unit(s) may be a single processor or a multi-core processor in different embodiments. Some instructions are passed to and executed by the GPU 1115. The GPU 1115 can offload various computations or complement the image processing provided by the processing unit(s) 1110.

The read-only-memory (ROM) 1130 stores static data and instructions that are used by the processing unit(s) 1110 and other modules of the electronic system. The permanent storage device 1135, on the other hand, is a read-and-write memory device. This device is a non-volatile memory unit that stores instructions and data even when the electronic system 1100 is off. Some embodiments of the present disclosure use a mass-storage device (such as a magnetic or optical disk and its corresponding disk drive) as the permanent storage device 1135.

Other embodiments use a removable storage device (such as a floppy disk, flash memory device, etc., and its corresponding disk drive) as the permanent storage device. Like the permanent storage device 1135, the system memory 1120 is a read-and-write memory device. However, unlike storage device 1135, the system memory 1120 is a volatile read-and-write memory, such a random access memory. The system memory 1120 stores some of the instructions and data that the processor uses at runtime. In some embodiments, processes in accordance with the present disclosure are stored in the system memory 1120, the permanent storage device 1135, and/or the read-only memory 1130. For example, the various memory units include instructions for processing multimedia clips in accordance with some embodiments. From these various memory units, the processing unit(s) 1110 retrieves instructions to execute and data to process in order to execute the processes of some embodiments.

The bus 1105 also connects to the input and output devices 1140 and 1145. The input devices 1140 enable the user to communicate information and select commands to the electronic system. The input devices 1140 include alphanumeric keyboards and pointing devices (also called “cursor control devices”), cameras (e.g., webcams), microphones or similar devices for receiving voice commands, etc. The output devices 1145 display images generated by the electronic system or otherwise output data. The output devices 1145 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 11, bus 1105 also couples electronic system 1100 to a network 1125 through a network adapter (not shown). In this manner, the computer can be a part of a network of computers (such as a local area network (“LAN”), a wide area network (“WAN”), or an Intranet, or a network of networks, such as the Internet. Any or all components of electronic system 1100 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 7 and FIG. 10) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video decoding method comprising:
receiving data for a block of pixels to be decoded as a current block of a current picture of a video;
receiving a motion vector that references a block of pixels in a reference picture based on the received data;
refining the motion vector by examining pixels in the reference picture that are identified based on the refined motion vector, wherein the refinement of the motion vector is constrained by a refinement range; and
decoding the current block by using the refined motion vector to reconstruct the current block.

2. The video decoding method of claim 1, wherein the refinement range is signaled in at least one of a sequence level, a picture level, and slice level.

3. The video decoding method of claim 1, further comprising deriving the refinement range based on a characteristic of the current block or the current picture.

4. The video decoding method of claim 1, wherein the motion vector is refined in a plurality of refinement passes.

5. The video decoding method of claim 4, wherein the refinement range is applied to two or more refinement passes.

6. The video decoding method of claim 4, wherein the refinement of the motion vector in each refinement pass is constrained by a different refinement range.

7. The video decoding method of claim 6, wherein a plurality of refinement ranges are signaled for the plurality of refinement passes.

8. The video decoding method of claim 4, wherein the refinement range limits the modification of the motion vector in each refinement pass.

9. The video decoding method of claim 8, wherein the modification of the motion vector is constrained to maintain the integer portion of the motion vector.

10. The video decoding method of claim 1, wherein using the refined motion vector to reconstruct the current block comprises generating a set of prediction samples for motion compensation based on the refined motion vector, wherein prediction samples within a retrieval range are generated by retrieving pixel samples of a reference picture from a memory, and prediction samples beyond the retrieval range are generated without accessing the memory.

11. The video decoding method of claim 10, wherein the retrieval range encompasses only pixel samples of the reference picture that are identified by the original motion vector for generating the set of prediction samples for motion compensation and not pixel samples that are not identified by the original motion vector for generating the set of prediction samples for motion compensation.

12. The video decoding method of claim 1, further comprising:
upon determining that activated reference pictures pair exists in two reference picture lists, receiving signaled information related to the refinement of the motion vector.

13. The video decoding method of claim 12, wherein the signaled information comprises an indication for enabling or disabling the refinement of the motion vector at slice level.

14. A video coding method comprising:
receiving data for a block of pixels to be encoded or decoded as a current block of a current picture of a video;
receiving a motion vector that references a block of pixels in a reference picture based on the received data;
refining the motion vector by examining pixels in the reference picture that are identified based on the refined motion vector, wherein the refinement of the motion vector is constrained by a refinement range; and
encoding or decoding the current block by using the refined motion vector.

15. An electronic apparatus comprising:
a video coding circuit configured to perform operations comprising:
receiving data for a block of pixels to be encoded or decoded as a current block of a current picture of a video;
receiving a motion vector that references a block of pixels in a reference picture based on the received data;
refining the motion vector by examining pixels in the reference picture that are identified based on the refined motion vector, wherein the refinement of the motion vector is constrained by a refinement range; and
encoding or decoding the current block by using the refined motion vector.
